(19) United States
(12) Patent Application Publication
(10) Pub. No.: US 2019/0212489 A1
(43) Pub. Date: Jul. 11, 2019

(54) OPTICAL MEMBER, LIGHTING DEVICE, AND DISPLAY DEVICE

(71) Applicant: SHARP KABUSHIKI KAISHA, Sakai City, Osaka (JP)

(72) Inventor: QINGLE XU, Sakai City (JP)

(73) Assignee: SHARP KABUSHIKI KAISHA, Sakai City, Osaka (JP)

(21) Appl. No.: 16/330,672

(22) PCT Filed: Sep. 6, 2017
(86) PCT No.: PCT/JP2017/032033

§ 371 Date: Mar. 5, 2019

(30) Foreign Application Priority Data
Sep. 13, 2016 (JP) 2016-178559

(51) Int. Cl. F21V 8/00; G02F 1/1335

(52) U.S. Cl. CPC G02B 6/0088; G02B 6/0025; G02F 1/133514; G02F 1/133606; G02B 6/0055

(57) ABSTRACT

An optical member 24 includes an optical sheet 15 and a frame (a light blocking member) 16. The optical sheet 15 includes a pair of plate surfaces and one of the plate surfaces is a light entering plate surface 15a through which light enters and another one of the plate surfaces is a light exit plate surface 15b through which the light exits. The optical sheet 15 includes an optical component that provides an optical effect on transmission light. The frame 16 has a light blocking property and extends along an edge section 15c of the optical sheet 15 and the edge section 15c is put within the frame 16. Accordingly, a frame width can be reduced.

### TECHNICAL FIELD

The present invention relates to an optical member, a lighting device, and a display device.

### BACKGROUND ART

An example of a liquid crystal display device described in Patent Document 1 has been known. Such a liquid crystal display device includes a casing and an LCD unit that is arranged fixedly in the casing. The casing includes a front case and a rear cover and the front case is integrally formed of frame-like sheet metal with resin. The front frame includes a frame-like front plate portion and a sidewall reinforcing plate portion that are bent and connected to each other. The sidewall reinforcing plate portion is formed by insert molding during injection molding of the front case to form a front case sidewall portion integrally with resin, whereby a storage space having a high rigidity for receiving and fixing the LCD unit is formed by the front plate portion and the front case sidewall portion. Retaining ribs for retaining the LCD unit arranged and installed in the storage space are provided in positions facing the front plate portion of the rear cover.

### RELATED ART DOCUMENT

### Patent Document

Patent Document 1: Japanese Unexamined Patent Application Publication No. 2009-288671

### Problem to be Solved by the Invention

In the above described liquid crystal display device, the optical sheet is a separate component from the LCD frame that positions and holds the optical sheet. Therefore, in arranging the optical sheet within the LCD frame, the optical sheet may be arranged over the LCD frame. To obviate such arrangement, a space is required to be provided between the LCD frame and the optical sheet. Also for absorbing a dimension tolerance that may be caused in producing the optical sheet and the LCD frame, the space between the LCD frame and the optical sheet is necessary. However, such a space may increase a frame width of the liquid crystal display device.

### DISCLOSURE OF THE PRESENT INVENTION

The present invention was made in view of the above circumstances. An object of the invention is to reduce a frame width.

### Means for Solving the Problem

An optical member of the present invention includes an optical sheet and a light blocking member. The optical sheet includes a pair of plate surfaces and one of the plate surfaces is a light entering plate surface through which light enters and another one of the plate surfaces is a light exit plate surface through which the light exits, and the optical sheet includes an optical component that provides an optical effect on transmission light. The light blocking member has a light blocking property and extends along an edge section of the optical sheet and the edge section is put within the light blocking member.

According to such a configuration, the light blocking member that extends along the edge section of the optical sheet and includes the edge section therein blocks light rays that may leak through the edge surface of the optical sheet. Thus, the leaking of light is less likely to be caused. In a configuration including the light blocking member and the optical sheet as separate components like the prior art, a space is necessary between the optical sheet and the light blocking member for easy assembling of the optical sheet and the light blocking member or absorbing dimension errors of the optical sheet and the light blocking member. However, the light blocking member and the optical sheet are integrally formed by fitting the edge section within the light blocking member. Therefore, the above described space is not necessary and the frame width of the optical member can be reduced by a dimension of the space. Further, according to the configuration of the light blocking member integrally including the optical sheet, the number of components is decreased and the management of the components becomes easy and the number of mounting steps is decreased.

Preferable embodiments of the optical sheet of the present technology may include the following configurations.

(1) The optical sheet may be made of material having linear expansion coefficient greater than that of the light blocking member and the edge section may be put within the light blocking member such that the optical sheet is applied with tension to be pulled outwardly along the plate surfaces. In case of thermal expansion of the optical sheet and the light blocking member, the optical sheet has greater linear expansion coefficient and the edge section is fixed by the light blocking member and therefore, an inward reaction force acts on the optical sheet. The tension acts on the optical sheet to be pulled outward by the light blocking member along the plate surface thereof and the reaction force is cancelled by the tension. Therefore, deformation such as warping or deflection is less likely to be caused on the optical sheet due to the relatively great linear expansion coefficient of the optical sheet.

(2) The optical sheet may include the optical component that forms an uneven structure on one of the light entering plate surface and the light exit plate surface. According to such a configuration, the edge section of the optical sheet is included within the light blocking member and the material of the light blocking member is put into spaces included in the optical component at the edge section of the optical sheet and optical sheet is fixed by the light blocking member. The optical component forms the uneven surface of one of the light entering plate surface and the light exit plate surface. Thus, the optical sheet and the light blocking member are integrally included with each other more firmly.

(3) The light blocking member may be arranged to cover the light entering plate surface and the light exit plate surface of the edge section of the optical sheet. According to such a configuration, the edge section of the optical sheet is appropriately blocked from light by the light blocking member. The optical sheet is held firmly by the light blocking member.

(4) The optical sheet may include optical sheets that are stacked on each other and the optical member may further include a plate surface fixing member that is between the plate surfaces of the optical sheets at the edge sections. According to such a configuration, the edge sections of the optical sheets are fixed with the plate surface fixing member. The plate surface fixing member is between the plate surfaces of the optical sheets at the edge sections thereof. Therefore, in producing the optical member, even if material of the light blocking member would enter a space between the edge sections of the optical sheets that are overlapped with each other, the plate surface fixing member restricts the material from entering the space.

(5) The optical sheet may include optical sheets that are stacked on each other and the optical member may further include an edge surface fixing member that is in contact with edge surfaces of the optical sheets and extends over the edge surfaces. According to such a configuration, the edge sections of the optical sheets are fixed to each other with the edge surface fixing member. The edge surface fixing member is contacted with the edge surfaces of the optical sheets and extends over the edge surfaces. Therefore, in producing the optical member, even if material of the light blocking member would enter a space between the edge sections of the optical sheets that are overlapped with each other, the edge surface fixing member restricts the material from entering the space.

To solve the above problem, a lighting device of the present technology includes the above optical member, a light source that supplies light to the optical sheet, and a light guide plate. The light guide plate has outer peripheral edge surface and a pair of plate surfaces, and a part of the outer peripheral edge surface is a light entering edge surface through which light from the light source enters and one of the plate surfaces is a light guide plate light exit plate surface that is opposite the light entering plate surface of the optical sheet and through which the light exits. The light blocking member includes a light guide plate pressing section that presses edge section of the light guide plate from a light guide plate light exit plate surface side.

According to the lighting device having such a configuration, the light emitted by the light source enters the light guide plate through the light entering edge surface and travels within the light guide plate. Then, the light exits the light guide plate through the light guide plate light exit plate surface toward the light entering plate surface of the optical sheet. The light guide plate is pressed from the light guide plate light exit plate surface side at the edge section thereof by the light guide plate pressing section of the light blocking member, and the position relation of the light guide plate and the optical sheet is appropriately maintained. Therefore, the optical performances of the light guide plate and the optical sheet can be exerted effectively.

Preferable embodiments of the lighting device of the present technology may include the following configurations.

(1) The lighting device may further include a casing in which the optical sheet, the light blocking member, and the light source are arranged. The casing may include a side section that is in contact with an outer surface of the light blocking member. According to such a configuration, the side section of the casing in which the optical sheet, the light blocking member, and the light source are arranged is contacted with the outer surface of the light blocking member and the light leaking is further less likely to be caused. The optical sheet and the light blocking member are integrally included and therefore, heat from the optical sheet is effectively transferred to the side section of the casing through the light blocking member and dissipates.

To solve the above problem, a display device of the present technology includes the above lighting device and a display panel displaying an image with using light supplied by the lighting device. The light blocking member includes a panel receiving section that receives an edge section of the display panel.

According to the display device having such a configuration, the edge section of the display panel is received by the panel receiving section of the light blocking member such that the position relation of the display panel and the optical sheet can be appropriately maintained. Accordingly, the light exiting through the light exit plate surface of the optical sheet can be appropriately supplied to the display panel and good display quality can be obtained.

### Advantageous Effect of the Invention

According to the present invention, a frame width can be reduced.

### BRIEF DESCRIPTION OF THE DRAWINGS

FIG. 1 is an exploded plan view illustrating a general configuration of a liquid crystal display device according to a first embodiment.

FIG. 2 is a plan view of a casing and an optical member of a backlight unit included in the liquid crystal display device.

FIG. 3 is a cross-sectional view of the liquid crystal display device taken along line A-A in FIG. 2.

FIG. 4 is a cross-sectional view of the liquid crystal display device taken along line B-B in FIG. 2.

FIG. 5 is an enlarged cross-sectional view illustrating edge sections of optical sheets and a light blocking member included in the optical member.

FIG. 6 is a cross-sectional view illustrating edge sections of optical sheets and a light blocking member included in an optical member according to a second embodiment of the present invention.

FIG. 7 is a cross-sectional view illustrating edge sections of optical sheets and a light blocking member included in an optical member according to a third embodiment of the present invention.

FIG. 8 is a cross-sectional view illustrating a cross-sectional configuration of a liquid crystal display device according to a fourth embodiment taken along a short-side direction.

### MODES FOR CARRYING OUT THE INVENTION

### First Embodiment

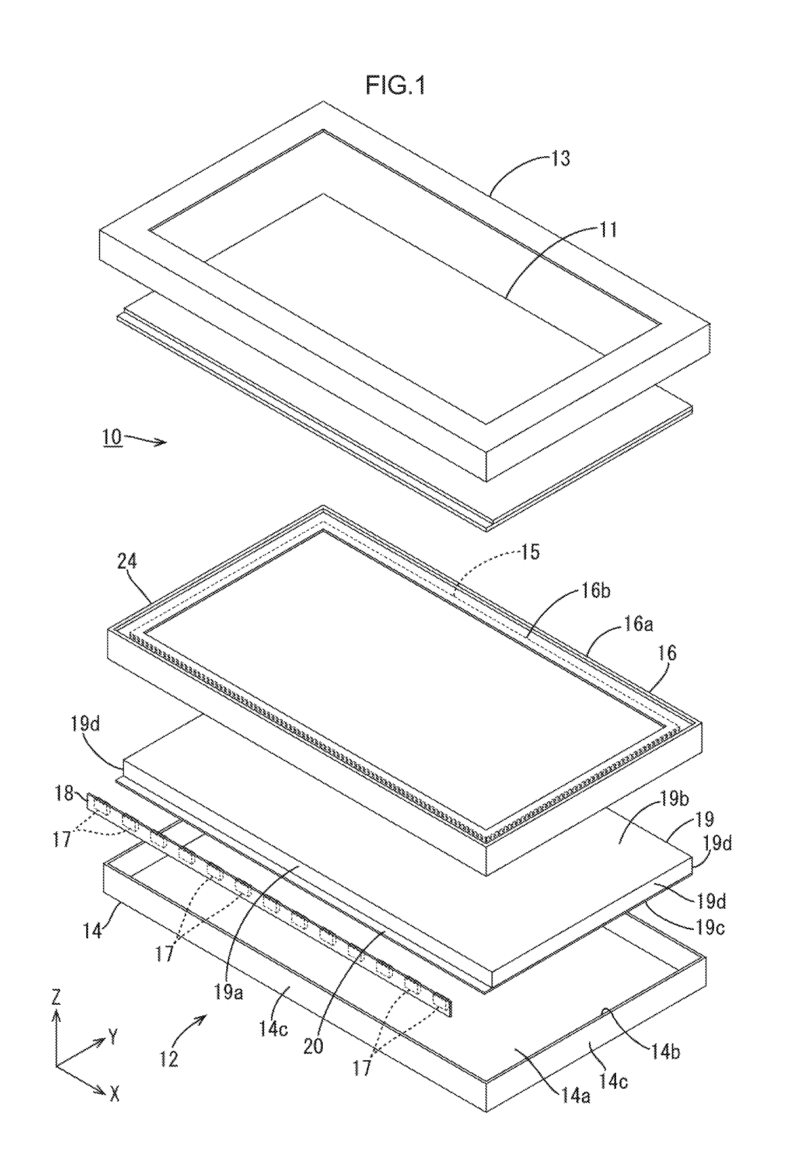

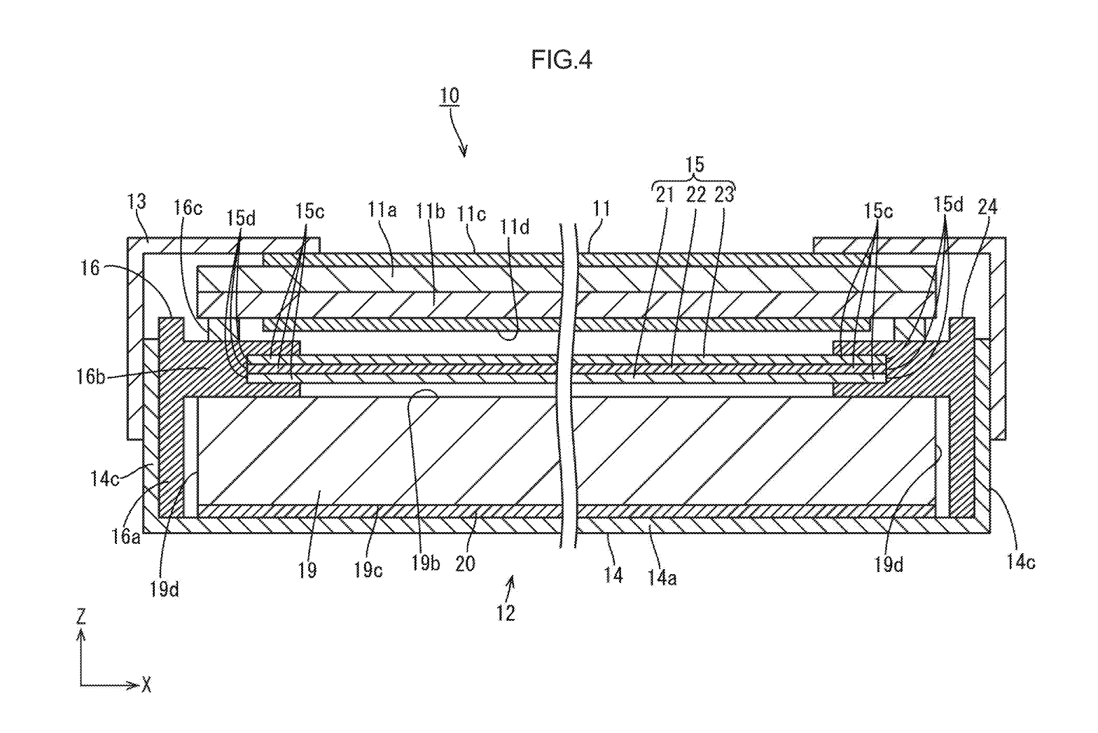

A first embodiment of the present technology will be described with reference to FIGS. 1 to 5. In the present embodiment, a liquid crystal display device (a display device) 10 will be described. X-axis, Y-axis and Z-axis may be indicated in the drawings. The axes in each drawing correspond to the respective axes in other drawings. An upper side and a lower side in FIG. 4 correspond to a front side and a back side, respectively.

As illustrated in FIG. 1, the liquid crystal display device 10 of the present embodiment has a laterally elongated quadrangular (rectangular) shape and includes a liquid crystal panel 11 (a display panel) and a backlight unit 12 (a lighting device). The liquid crystal panel 11 is configured to display images. The backlight unit 12 is an external light source configured to supply light to the liquid crystal panel 11. The liquid crystal panel 11 and the backlight unit 12 are integrally held by a frame-shaped bezel 13. The liquid crystal display device 10 may be preferably used in portable information terminals such as tablet computers or a vehicular built-in system such as a car navigation system. The liquid crystal panel 11 is in a range between some inches to ten and some inches. Namely, the liquid crystal panel 11 is in a size that is classified as a small or a small-to-medium.

Next, the liquid crystal panel 11 and the backlight unit 12 included in the liquid crystal display device 10 will be described. As illustrated in FIG. 1, the liquid crystal panel (a display panel) 11 has a laterally elongated rectangular shape in a plan view. The liquid crystal panel 11 includes a pair of glass substrates 11a, 11b that are bonded to each other while having a predetermined gap therebetween and a liquid crystal layer (not illustrated) between the glass substrates 11a and 11b. The liquid crystal layer includes liquid crystal molecules that are substances with optical characteristics that vary according to application of an electric field. On an inner surface of one glass substrate (an array substrate, an active matrix substrate) 11, switching components (such as TFTs) and pixel electrodes are arranged in a matrix and an alignment film is arranged. The switching components are connected to source lines and gate lines that are perpendicular to each other. The pixel electrodes are arranged in quadrangular areas that are surrounded by the source lines and the gate lines. On an inner surface of another glass substrate (a counter substrate, a CF substrate), color filters, a light blocking layer (a black matrix), a counter electrode, and an alignment film are arranged. The color filters include color portions of red (R), green (G) and blue (B) that are arranged in a matrix. The light blocking layer is formed in a grid and arranged between the color portions. The counter electrode is arranged in a solid pattern to be opposite the pixel electrodes. Polarizing plates 11c, 11d are bonded to outer surfaces of the glass substrates 11a and 11b, respectively. A long-side direction, a short-side direction and a thickness direction of the liquid crystal panel 11 match the X-axis direction, the Y-axis direction and the Z-axis direction, respectively.

As illustrated in FIG. 1, the backlight unit 12 includes a casing 14 and an optical member 24. The casing 14 has a substantially box-shape having a light exit section 14b that opens toward an external front side (toward the liquid crystal panel 11, a light exit side). The optical member 24 is arranged to cover the light exit section 14b of the casing 14. The optical member 24 includes optical sheets 15 and a frame (a light blocking member) 16 that surrounds the optical sheets 15. The optical member 24 will be described in detail later. LEDs 17, which are a light source, a LED board 18 including the LEDs 17 thereon, a light guide plate 19, and a reflection sheet (a reflecting member) 20 are arranged in the casing 14. Light from the LEDs 17 travels within the light guide plate 19 and toward the optical sheets 15 (the liquid crystal panel 11). The reflection sheet 20 is disposed on the light guide plate 19 on a back side surface thereof. The backlight unit 12 includes the LED board 18 at one of long edges of the back light unit 12 and the LEDs 17 mounted on the LED board 18 are arranged on one of the long-side edges of the liquid crystal panel 11. Thus, the backlight unit 12 of this embodiment is an edge light type (a side-light type) backlight unit of one-side light entering type in which light from the LEDs 17 enters the light guide plate 19 through only one side. Next, components included in the backlight unit 12 will be described in detail.

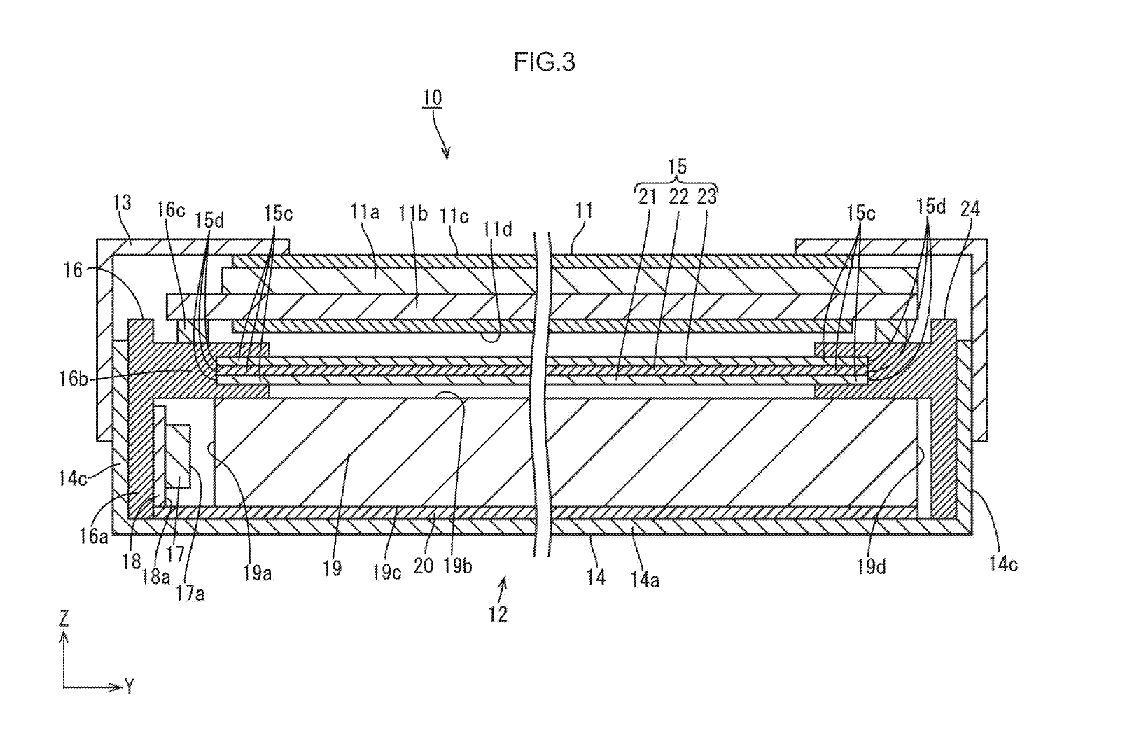

The casing 14 is made of metal and as illustrated in FIGS. 1 and 3, the casing 14 has a bottom section 14a having a laterally-elongated rectangular shape similar to that of the liquid crystal panel 11 and side sections 14c each of which extends from each outer side edge of the bottom section 14a. The casing 14 has a shallow box shape opening frontward as a whole. In the casing 14 (the bottom section 14a), a long-side direction matches the X-axis direction and a short-side direction matches the Y-axis direction. A frame 16 and a bezel 13 are fixed to the side sections 14c.

As illustrated in FIG. 3, the LEDs 17 are mounted on the surface of the LED board 18 and each LED 17 is a so-called top-surface-emitting type LED and a light emission surface 17a of each LED 17 faces an opposite side from the LED board 18. The LED 17 includes an LED chip that emits light rays of a single color of blue and phosphors (yellow phosphors, green phosphors, red phosphors) are dispersed in a sealing material and the LED 17 emits substantially white light as a whole.

As illustrated in FIGS. 1 and 3, The LED board 18 is formed of an elongated plate extending in the long-side direction (the X-axis direction) of the casing 14 and has a mounting surface 18a on which the LEDs 17 are mounted. The LED board 18 is arranged in the casing 14 such that the mounting surface 18a is opposite an edge surface (a light entering edge surface 19a) of the light guide plate 19. The LED board 18 is mounted on the frame 16 such that a plate surface thereof opposite from the mounting surface 18a is contacted with an inner surface of an outer frame section 16a of the frame 16, which will be described later. Wiring (not illustrated) for supplying power to the LEDs 17 is arranged with patterning on the LED 17 mounting surface 18a of the LED board 18 and the LEDs 17 are arranged at intervals in the X-axis direction.

The light guide plate 19 is made of synthetic resin material that is substantially transparent and has refractive index sufficiently higher than that of air. As illustrated in FIGS. 1 and 3, the light guide plate 19 is arranged directly below the liquid crystal panel 11 and the optical sheets 15 within the casing 14 such that a plate surface thereof is parallel to plate surfaces of the liquid crystal panel 11 and the optical sheets 15. The light guide plate 19 is a plate having thickness greater than that of the optical sheets 15 and a laterally elongated quadrangular plan view shape. The light guide plate 19 includes peripheral edge surfaces including a pair of short-side edge surfaces and a pair of long-side edge surfaces that are perpendicular to each other. A left-side long-side edge surface of the peripheral edge surfaces of the light guide plate 19 in FIG. 3 is a light entering edge surface (a light source opposite edge surface) 19a through which light rays from the LEDs 17 directly enter. Three peripheral edge surfaces of the light guide plate 19 other than the light entering edge surface 19a (another long-side edge surface and a pair of short-side edge surfaces) are not opposite the LEDs 17 and are non-light entering edge surfaces (light source non-opposed edge surfaces) 19d. The light rays emitted by the LEDs 17 do not directly enter through the non-light entering edge surfaces 19d. One of the front and rear side plate surfaces of the light guide plate 19 facing the front side (the liquid crystal panel 11 side, the optical sheet 15 side) is a light guide plate light exit plate surface 19b through which the light rays exit toward the liquid crystal panel 11 and the optical sheets 15. The other plate surface facing the back side is an opposite plate surface 19c that is opposite from the light guide plate light exit plate surface 19b. According to such a configuration, the light rays emitted by the LEDs 17 in the Y-axis direction enter the light guide plate 19 through the light entering edge surface 19a and travels within the light guide plate 19 and exit the light guide plate 19 through the light guide plate light exit plate surface 19b toward the optical sheets 15 (the front side, the light exit side).

As illustrated in FIG. 3, the reflection sheet 20 is disposed such that a plate surface thereof is parallel to a plate surface of the light guide plate 19 and covers the opposite plate surface 19c of the light guide plate 19. The reflection sheet 20 has high light reflectivity and reflects light rays leaking through the opposite plate surface 19c of the light guide plate 19 toward the front side (the light guide plate light exit plate surface 19b) effectively. The reflection sheet 20 has an outline shape larger than that of the light guide plate 19 and a left long-side edge thereof in FIG. 3 projects toward the LEDs 17 than the light entering edge surface 19a.

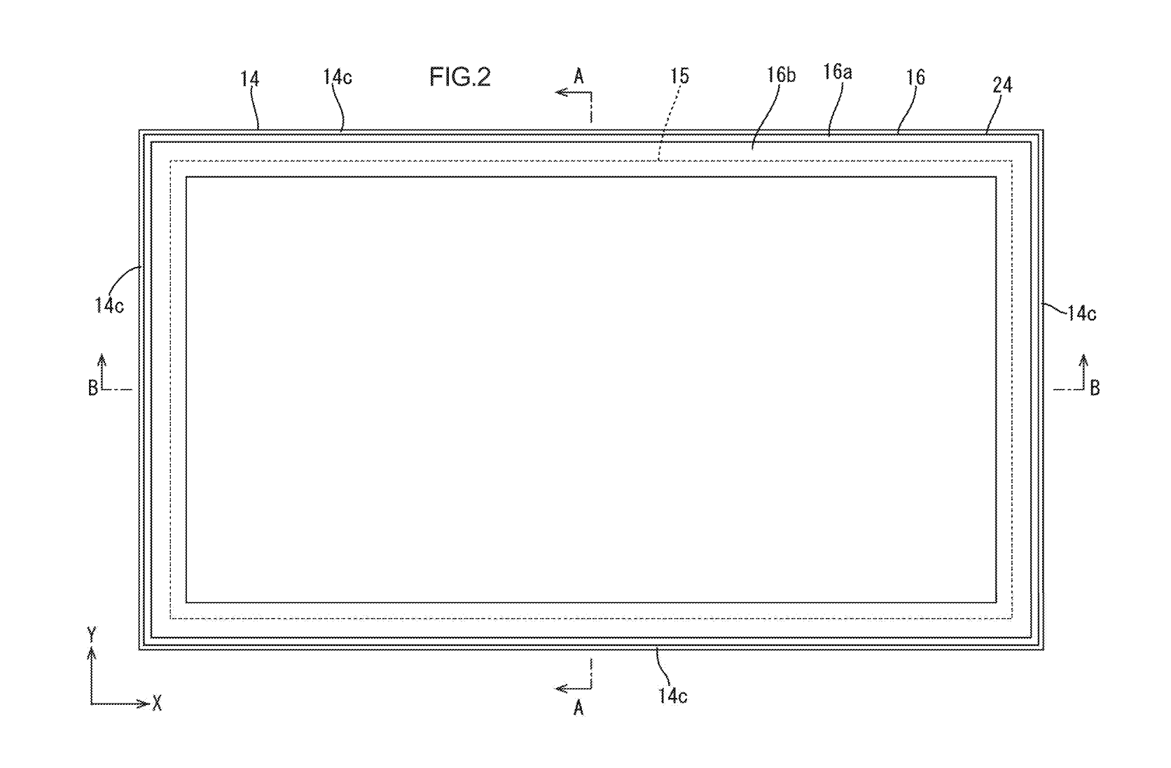

Next, the optical member 24 will be described in detail. As illustrated in FIGS. 1 and 2, the optical sheet 15 has a laterally-elongated rectangular plan view shape similar to that of the liquid crystal panel 11 and the casing 14. The long-side direction matches the X-axis direction, the short-side direction matches the Y-axis direction, and the thickness direction perpendicular matches the Z-axis direction. The optical sheet 15 is made from substantially transparent synthetic resin (having transmissivity) such as polyethylene terephthalate (PET). The synthetic resin of the optical sheets 15 has linear expansion coefficient greater than that of the synthetic resin of the frame 16. As illustrated in FIG. 3, the optical sheet 15 has front and rear plate surfaces and the rear plate surface (on an opposite side from the light exit side, facing the light guide plate 19 side) is a light entering plate surface 15a through which light enters and the front plate surface (on the light exit side, the liquid crystal panel 11 side) is a light exit plate surface 15b through which light exits. The optical sheets 15 are disposed to cover the light exit section 14b of the casing 14 and between the liquid crystal panel 11 and the light guide plate 19. The optical sheet 15 is opposite the plate surfaces of the liquid crystal panel 11 and the light guide plate 19. Namely, the optical sheets 15 are on an exit side of a light travelling path with respect to the LEDs 17. The optical sheets 15 include three optical sheets laminated with each other and each of the optical sheets includes optical components that exert predetermined optical effects on the transmission light. Specifically, in the optical sheet 15 of the present embodiment, the three optical sheets include a micro lens sheet 21, a prism sheet 22, and a reflective-type polarizing sheet 23. The micro lens sheet 21 exerts isotropic light collecting effects on the light. The prism sheet 22 exerts anisotropic light collecting effects on the light. The reflective-type polarizing sheet 23 reflects light with polarizing. The optical sheet 15 includes the micro lens sheet 21, the prism sheet 22, and the reflective-type polarizing sheet 23 that are layered on each other from the rear side in this order. The micro lens sheet 21 that is disposed closest to the rear side is disposed such that the light entering plate surface 15a is opposite the light guide plate light exit plate surface 19b.

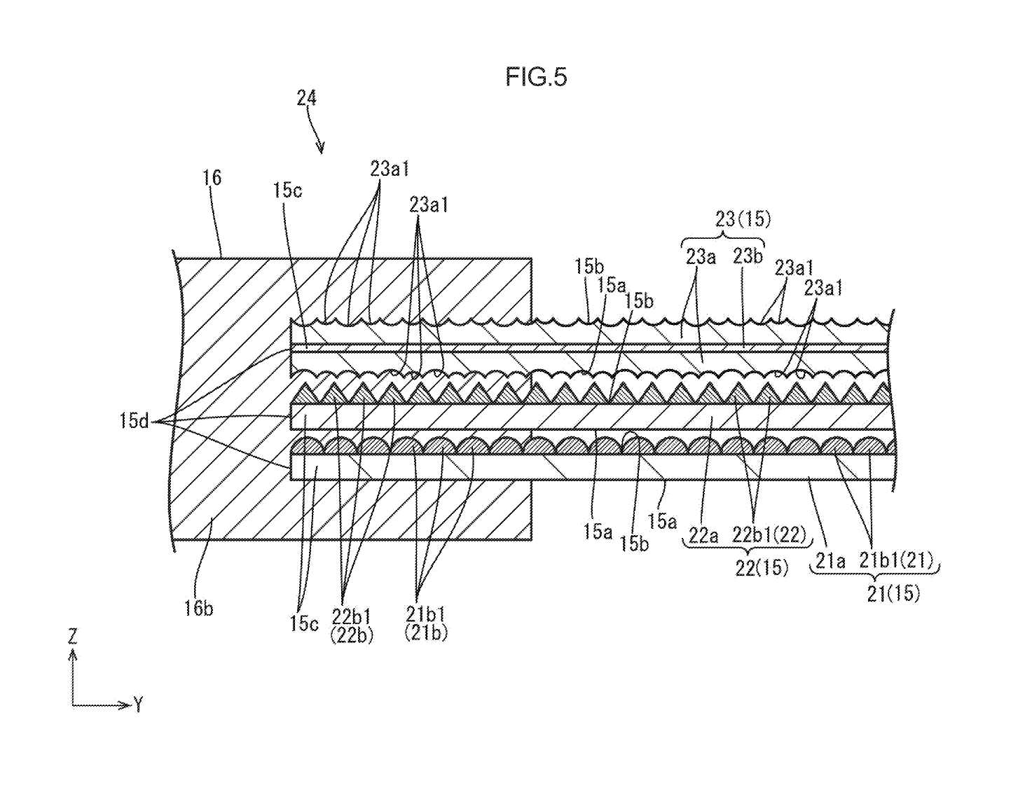

As illustrated in FIG. 5, the micro lens sheet 21 includes a base member 21a and a micro lens portion (optical component) 21b provided on a front-side plate surface of the base member 21a. The micro lens portion 21b includes unit micro lenses 21b1 that are planarly arranged in the X-axis direction and in the Y-axis direction in a matrix (in rows and columns). Each of the unit micro lenses 21b1 has a substantially circular plan view shape and is a convex lens of semispherical shape as a whole. According to such a configuration, the micro lens sheet 21 exerts light collecting effects on the light with respect to the X-axis direction and the Y-axis direction isotropically (isotropic light collecting effects). In the micro lens sheet 21, a rear-side plate surface of the base member 21a is the light entering plate surface 15a and a front-side plate surface of the base member 21a is the light exit plate surface 15b.

As illustrated in FIG. 5, the prism sheet 22 includes a base member 22a and a prism portion (optical component) 22b provided on a front-side plate surface of the base member 22a. The prism portion 22b includes unit prisms 22b1 each of which extends in the X-axis direction and that are arranged in the Y-axis direction. Each of the unit prisms 22b1 is formed in a rail (a linear shape) parallel to the X-axis direction in a plan view and has a substantially isosceles triangular cross-sectional shape taken in the Y-axis direction. With such a configuration, light collecting effects are selectively exerted on the light rays with respect to the Y-axis direction (a direction in which the unit prisms 22b1 are arranged, a direction perpendicular to an extending direction of the unit prism 22b1) by the prism sheet 22 (anisotropic light collecting effects). In the prism sheet 22, a rear-side plate surface of the base member 22a is the light entering plate surface 15a and a front-side plate surface of the base member 22a is the light exit plate surface 15b.

As illustrated in FIG. 5, the reflective-type polarizing sheet 23 includes a reflective-type polarizing film (optical component) 23b that reflects and polarizes light rays, and a pair of diffuser films 23a that sandwich the reflective-type polarizing film 23b. The reflective-type polarizing film 23b has a multi-layer structure including layers having different refractive index layered on each other. Among the light rays, p-wave is passed through the reflective-type polarizing film 23b and s-wave is reflected by the reflective-type polarizing film 23b to the rear side. The s-wave reflected by the reflective-type polarizing film 23b reflects off a reflection sheet 20, which will be described later, again to the front side and separated into s-wave and p-wave. Thus, the reflective-type polarizing sheet 23 includes the reflective-type polarizing film 23b and reflects the s-wave that is to be absorbed by the polarizing plates 11c, 11d of the liquid crystal panel 11 if not including the reflective-type polarizing film 23b. The reflective-type polarizing sheet 23 reflects the s-wave to the rear side (toward the reflection sheet 20) and the reflected s-wave can be reused and light use efficiency (brightness) can be improved. Each of the diffuser films 23a is thicker than the reflective-type polarizing film 23b and is subjected to embossing processing on a plate surface thereof opposite from the surfaces facing the reflective-type polarizing film 23b. Thus, the diffuser film 23a has minute recess sections (optical component) 23a1 on the plate surface thereof and diffusing effects are exerted on the light by the minute recess sections 23a1. In the reflective-type polarizing sheet 23, a rear-side plate surface (opposite side from the reflective-type polarizing film 23b) of the rear-side diffuser film 23a is the light entering plate surface 15a and a front-side plate surface (opposite side from the reflective-type polarizing film 23b) of the front-side diffuser film 23a is the light exit plate surface 15b.

The frame 16 included in the optical member 24 is formed of synthetic resin having a light blocking property and has a white surface having good light reflectivity. The synthetic resin of the frame 16 has linear expansion coefficient smaller than that of the synthetic resin of each of the optical sheet 15. As illustrated in FIGS. 2 to 4, the frame 16 has a frame shape extending along peripheral edges of the light guide plate 19 and the optical sheets 15 as a whole. The frame 16 includes an outer frame section 16a that is on a relatively outer peripheral side and an inner frame section (a light guide plate pressing section, a panel receiving section) 16b that is on a relatively inner peripheral side. The outer frame section 16a projects toward. the front and rear sides along the Z-axis direction with respect to the inner frame section 16b. The outer frame section 16a is sandwiched between the light guide plate 19 and the side section 14c of the casing 14 with respect to the X-axis direction or the Y-axis direction. The outer surface of the outer frame section 16a is contacted with an inner surface of the side section 14c of the casing 14. The outer frame section 16a has an inner peripheral surface that is opposite the plate surface of the LED board 18 opposite from the mounting surface 18a and each of the non-light entering edge surfaces 19d of the light guide plate 19. Therefore, the light that is emitted by the LEDs 17 and does not directly enter through the light entering edge surface 19a of the light guide plate 19 and reflected is reflected by the outer frame section 16a and returned to the light entering edge surface 19a. The light exiting through the non-light entering edge surface 19d of the light guide plate 19 is reflected by the outer frame section 16a and returns to the non-light entering edge surface 19d.

As illustrated in FIGS. 3 and 4, the inner frame section 16b projects inwardly from the outer frame section 16a and has a cross-sectional shape of an eave. The inner frame section 16b overlaps the peripheral edge sections of the light guide plate 19 and the liquid crystal panel 11 in a plan view and is between the outer peripheral sections of the light guide plate 19 and the liquid crystal panel 11 with respect to the Z-axis direction. Therefore, the inner frame section 16b receives the peripheral edge section of the liquid crystal panel 11 from the rear side over substantially an entire periphery thereof. The inner frame section 16b presses the peripheral edge section of the liquid crystal panel 11 from the front side over substantially an entire periphery thereof. Accordingly, a space (a position relation) between the liquid crystal panel 11 and the light guide plate 19 in the Z-axis direction can be kept constant. A cushioning member 16c is disposed on a front surface of the inner frame section 16b and between the inner frame section 16b and the peripheral edge section of the liquid crystal panel 11. The cushioning member 16c is made of PORON (registered trademark), for example. The cushioning member 16c is formed in a frame shape extending along an entire periphery of the inner frame section 16b. The cushioning member 16c is disposed on the outer peripheral edge section of the inner frame section 16b.

As illustrated in FIGS. 3 and 4, the frame 16 of this embodiment receives edge sections 15c of the optical sheets 15 therein and the optical member 24 integrally includes the optical sheets 15 and the frame 16. According to such a configuration, in assembling the backlight unit 12, the optical member 24 integrally including the optical sheets 15 and the frame 16 is just arranged in the casing 14. Therefore, a space is not necessary between the optical sheets and the frame for easy assembling of separate components of the optical sheets and the frame or absorbing dimension errors as is in the prior art. Accordingly, a frame width of each of the optical member 24, the backlight unit 12 and the liquid crystal display device 10 can be reduced. Specifically, a frame width (a distance from an outer surface of the side section 14c of the casing 14 to the display area) of the liquid crystal display device 10 is largely reduced to about 1 mm to 1.2 mm and outer appearance is improved with good design. The number of components is decreased by integrally including the optical sheets 15 and the frame 16 and the management of the components becomes easy and the number of mounting steps is decreased. The optical sheets 15 and frame 16 are made of synthetic resin. Therefore, compared to a configuration that the optical sheets and the frame are made of different materials (for example, one of them is made of metal), the linear expansion coefficients thereof are less likely to differ from each other largely. Therefore, difference is less likely to be caused between the expansion/contraction amounts of the optical sheets 15 and the frame 16 in thermal expansion or thermal contraction. Therefore, deformation such as warping or deflection is less likely to be caused on the optical sheets 15 in thermal expansion or thermal contraction.

Specifically, as illustrated in FIGS. 3 and 4, the three optical sheets 15 are stacked on each other and are integrally fit into the inner frame section 16b of the frame 16 at the edge sections 15c thereof. The edge surfaces 15d of the optical sheets 15 are covered with the inner frame section 16b from outside. Therefore, even if the light that has entered the optical sheets 15 is to exit through the edge surfaces 15d, the light is reflected by the inner frame section 16b and less likely to leak through the edge surfaces 15d. The inner frame section 16b is formed in a frame shape surrounding the optical sheets 15 over an entire periphery. Therefore, the light that is to leak through the edge surfaces 15d of the optical sheets 15 is blocked over the entire periphery. Furthermore, the light entering plate surface 15a and the light exit plate surface 15b of the edge section 15c of the optical sheet 15 are covered with the inner frame section 16b. Therefore, the light that is to leak through the light entering plate surface 15a and the light exit plate surface 15b of the edge section 15c of the optical sheet 15 is also blocked by the inner frame section 16b. Thus, the inner frame section 16b has a good light blocking property and large holding force for holding the optical sheet 15. The edge sections 15c of the optical sheets 15 are fit into the inner peripheral section of the inner frame section 16b of the frame 16 and do not overlap the cushioning member 16c, which is arranged on the outer peripheral edge section of the inner frame section 16b, in a plan view.

As illustrated in FIG. 5, the edge sections 15c of the optical sheets 15 are fit into the frame 16 and have uneven plate surfaces that have the optical components thereon. Specifically, the micro lens sheet 21 has the unit micro lenses 21b1 of the micro lens portion 21b on the light exit plate surface 15b and the unit micro lenses 21b1 form the uneven surface. The prism sheet 22 has the unit prisms 22b1 of the prism portion 22b on the light exit plate surface 15b and the unit prisms 22b1 form the uneven surface. The reflective-type polarizing sheet 23 has the recess sections 23a1 on the light entering plate surface 15a and the light exit plate surface 15b and the recess sections 23a1 form the uneven surfaces. The synthetic resin of the frame 16 is put into spaces in each of the unit micro lenses 21b1, the unit prisms 22b1, the recess sections 23a1 that are included in the edge sections 15c of the optical sheets 15. Thus, the optical sheets 15 and the frame 16 are integrally formed with each other more firmly.

As illustrated in FIGS. 3 and 4, the inner frame section 16b in which the edge sections 15c of the optical sheets 15 are fit presses the light guide plate 19 from the front side. Therefore, the position relation of the optical sheets 15 and the light guide plate 19 in the Z-axis direction is appropriately kept and the optical performance thereof is effectively exerted. Further, the inner frame section 16b in which the edge sections 15c of the optical sheets 15 are fit receives the liquid crystal panel 11 from the rear side. Therefore, the position relation of the optical sheets 15 and the liquid crystal panel 11 in the Z-axis direction is appropriately kept. Accordingly, light that has exited through the light exit plate surface 15b of the optical sheet 15 is supplied appropriately to the liquid crystal panel 11 and display quality is improved. The side sections 14c of the casing 14 are contacted with the outer surface of the outer frame section 16a of the frame 16 over substantially an entire periphery. Therefore, light rays that do not directly enter from the LEDs 17 through the light entering edge surface 19a of the light guide plate 19 or light lays that leak through the non-light entering edge surface 19d of the light guide plate 19 are less likely to leak through a gap that may be between the outer frame section 16a and the side sections 14c. Heat generated from the optical sheets 15 is transferred effectively to the side sections 14c of the casing 14 through the frame 16 that is integrally included with the optical sheets 15 and dissipates.

A specific method of producing the optical member 24 will be described. In producing the optical member 24, the three optical sheets 15 each of which has been previously produced are used as a core and the frame 16 is molded with insert molding. More in detail, the three optical sheets 15 are stacked on each other and the edge sections 15c thereof are inserted in a molding die for the frame 16 and melted synthetic resin is supplied into the molding die. After the synthetic resin supplied in the molding die is cooled down and solidified and the molding die is opened, the edge sections 15c of the optical sheets 15 are included inside the inner frame section 16b of the frame 16. Thus, the optical member 24 integrally including the optical sheets 15 and the frame 16 together is obtained. The molding (insert molding) with resin for the frame 16 is performed while each optical sheet 15, which is a core member, being applied with tension to be pulled outward along the plate surface thereof. The tension acts on each optical sheet 15 radially from a center of the plate surface of each optical sheet 15. In the optical member 24 thus produced, the tension always acts on the optical sheets 15 such that the edge sections 15c are pulled outwardly by the frame 16 into which the edge sections 15c are fit over an entire periphery thereof. As described before, the optical sheet 15 has linear expansion coefficient greater than that of the synthetic resin of the frame 16. However, the edge sections 15c of the optical sheets 15 are fixed by the frame 16. Therefore, in case of thermal expansion of the optical sheets 15 and the frame 16, the optical sheets 15 receives an inward reaction force from the frame 16 that holds the edge sections 15c. As described before, the tension acts on the optical sheets 15 to be pulled outward by the frame 16 along the plate surface thereof and the reaction force is cancelled the tension. Therefore, deformation such as warping or deflection is less likely to be caused on the optical sheets 15 due to the relatively great linear expansion coefficient of the optical sheets 15.

As described before, the optical member 24 of this embodiment includes the optical sheet 15 and the frame (the light blocking member) 16. The optical sheet 15 includes a pair of plate surfaces and one of the plate surfaces is the light entering plate surface 15a through which light enters and another one is the light exit plate surface 15b through which the light exits. The optical sheet 15 includes an optical component that exerts a predetermined optical effect on the transmission light. The frame 16 has a light blocking property and extends along the edge section 15c of the optical sheet 15 and includes the edge section 15c therein.

According to such a configuration, the frame 16 that extends along the edge section 15c of the optical sheet 15 and includes the edge section 15c therein blocks light rays that may leak through the edge surface 15d of the optical sheet 15. Thus, the leaking of light is less likely to be caused. In a configuration including the frame and the optical sheet as separate components like the prior art, a space is necessary between the optical sheet 15 and the frame 16 for easy assembling of the optical sheets and the frame or absorbing dimension errors of the optical sheets and the frame. However, the frame 16 and the optical sheet 15 are integrally formed by fitting the edge sections 15c within the frame 16. Therefore, the above described space is not necessary and the frame width of the optical member 24 can be reduced by a dimension of the space. Further, according to the configuration of the frame 16 integrally including the optical sheets 15, the number of components is decreased and the management of the components becomes easy and the number of mounting steps is decreased.

The optical sheets 15 are made of synthetic resin having greater linear expansion coefficient than that of the frame 16. The frame 16 includes the edge sections 15c therein such that the tension acts on the optical sheets 15 to be pulled outwardly by the frame 16 along the plate surface thereof. In case of thermal expansion of the optical sheets 15 and the frame 16, the optical sheets 15 have greater linear expansion coefficient and the edge sections 15c are fixed by the frame 16 and therefore, an inward reaction force acts on the optical sheets 15. The tension acts on the optical sheets 15 to be pulled outward by the frame 16 along the plate surface thereof and the reaction force is cancelled by the tension. Therefore, deformation such as warping or deflection is less likely to be caused on the optical sheets 15 due to the relatively great linear expansion coefficient of the optical sheets 15.

The optical sheet 15 includes the optical component on one of the light entering plate surface 15a and the light exit plate surface 15b to form an uneven surface. According to such a configuration, the edge section 15c of the optical sheet 15 is included within the frame 16 and the material of the frame 16 is put into spaces included in the optical component at the edge section 15c of the optical sheet 15 and the optical sheet 15 is fixed by the frame 16. The optical component forms the uneven surface of one of the light entering plate surface 15a and the light exit plate surface 15b. Thus, the optical sheets 15 and the frame 16 are integrally included with each other more firmly.

The frame 16 covers the light entering plate surface 15a and the light exit plate surface 15b of the edge section 15c of the optical sheet 15. According to such a configuration, the edge section 15c of the optical sheet 15 is appropriately blocked from light by the frame 16. The optical sheet 15 is held firmly by the frame 16.

The backlight unit (the lighting device) 12 of the present embodiment includes the above-described optical member 24, the LEDs (the light source) 17 that supply light to the optical sheet 15, and the light guide plate 19 having outer peripheral edge surfaces and a pair of plate surfaces. A part of the outer peripheral edge surfaces is the light entering edge surface 19a through which the light from the LEDs 17 enters. One of the plate surfaces is the light guide plate light exit plate surface 19b that is opposite the light entering plate surface 15a of the optical sheet 15 and through which the light exits. The frame 16 includes the inner frame section (a light guide plate pressing section) 16b that presses the edge section of the light guide plate 19 from the light guide plate light exit plate surface 19b side. According to the backlight unit 12 having such a configuration, the light emitted by the LEDs 17 enters the light guide plate 19 through the light entering edge surface 19a and travels within the light guide plate 19. Then, the light exits the light guide plate 19 through the light guide plate light exit plate surface 19b toward the light entering late surface 15a of the optical sheet 15. The light guide plate 19 is pressed from the light guide plate light exit plate surface 19b side at the edge section thereof by the inner frame section 16b of the frame 16, and the position relation of the light guide plate 19 and the optical sheet 15 is appropriately maintained. Therefore, the optical performances of the light guide plate 19 and the optical sheet 15 can be exerted effectively.

The casing 14 is further included and the optical sheets 15, the frame 16, and the LEDs 17 are arranged in the casing 14 and includes the side sections 14c that are contacted with the outer surface of the frame 16. According to such a configuration, the side sections 14c of the casing 14 in which the optical sheets 15, the frame 16, and the LEDs are arranged are contacted with the outer surface of the frame 16 and the light leaking is further less likely to be caused. The optical sheets 15 and the frame 16 are integrally included and therefore, heat from the optical sheets 15 is effectively transferred to the side sections 14c of the casing 14 through the frame 16 and dissipates.

The liquid crystal display device (the display device) 10 of this embodiment includes the above described backlight unit 12 and the liquid crystal panel (the display panel) 11 that displays an image with using the light supplied by the backlight unit 12. The frame 16 includes the inner frame section (the panel receiving section) 16b that receives the edge section of the liquid crystal panel 11. According to the liquid crystal display device 10 having such a configuration, the edge section of the liquid crystal panel 11 is received by the inner frame section 16b of the frame 16 such that the position relation of the liquid crystal panel 11 and the optical sheet can be appropriately maintained. Accordingly, the light exiting through the light exit plate surface 15b of the optical sheet 15 can be appropriately supplied to the liquid crystal panel 11 and good display quality can be obtained.

### Second Embodiment

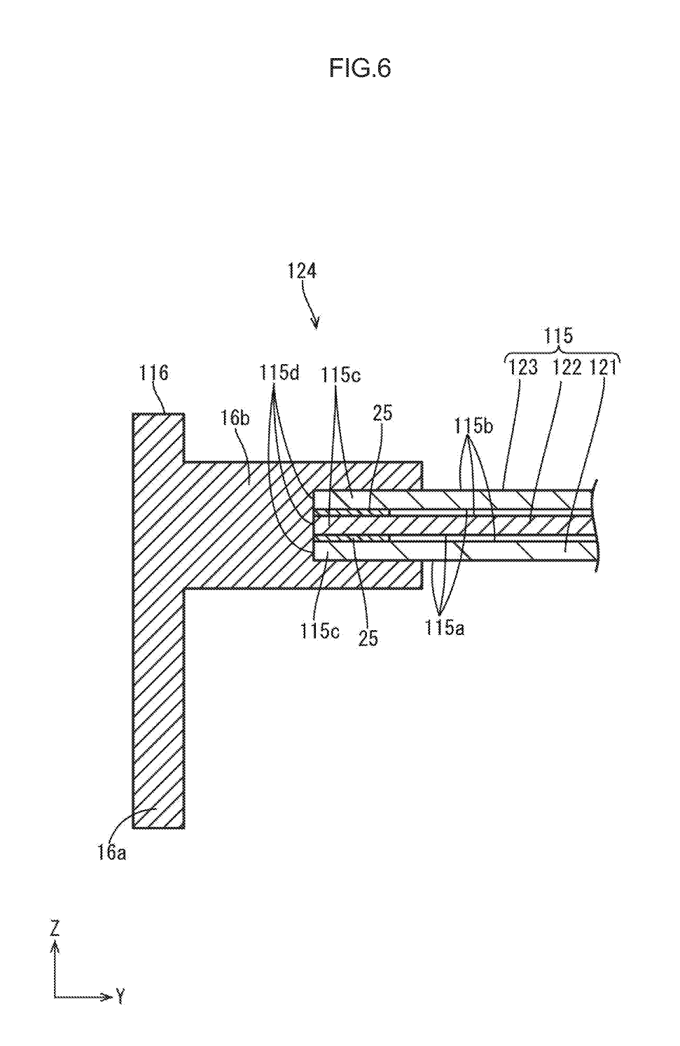

A second embodiment of the present technology will be described with reference to FIG. 6. The second embodiment further includes a plate surface fixing member 25 that is arranged between plate surfaces of optical sheets 115 and fixes the optical sheets 115. Configurations, operations, and effects same as those of the first embodiment will not be described.

As illustrated in FIG. 6, an optical member 124 of this embodiment includes the plate surface fixing member 25 between plate surfaces of the overlapped optical sheets 115 at edge sections 115c thereof. According to such a configuration, a space that may be between the plate surfaces of the overlapped optical sheets 115 at the edge sections 115c is closed by the plate surface fixing member 25. Therefore, in producing the optical member 124, even if material of a frame 116 would enter a space between the edge sections 115c of the optical sheets 115 that are overlapped with each other, the plate surface fixing member 25 restricts the material from entering the space. According to the present embodiment including the plate surface fixing member 25, a manufacturing cost can be reduced compared to a configuration of a third embodiment.

As illustrated in FIG. 6, the plate surface fixing member 25 is disposed between a micro lens sheet 121 and a prism sheet 122 that are directly overlapped with each other and also disposed between the prism sheet 122 and a reflective-type polarizing sheet 123 at the edge sections 115c thereof, respectively. Namely, two plate surface fixing members 25 (the number obtained by subtracting one from the number of stacked optical sheets 115) are included. The plate surface fixing member 25 includes a base member and a pair of adhering layers and is a so-called double-sided adhesive tape. The base member has front and back plate surfaces that are parallel to the plate surface of the optical sheet 115. The adhering layers are arranged on the respective front and back plate surfaces. The plate surface fixing member 25 is disposed between the edge sections 115c of the respective two optical sheets 115 that are directly overlapped with each other. The back-side adhering layer adheres to the light exit plate surface 115b of the edge section 115c of the back-side optical sheet 115 and the front-side adhering layer adheres to the light entering plate surface 115a of the edge section of the front-side optical sheet 115. Accordingly, the edge sections 115c of the two optical sheets 115 that are directly overlapped are fixed with each other. The plate surface fixing member 25 is provided over an entire periphery of the edge sections 115c of the optical sheets 115. The plate surface fixing member 25 may be formed in a frame shape extending over an entire periphery of the optical sheets 115. However, the plate surface fixing member 25 may he divided into four sections for the respective four edge sections 115c of the optical sheet 115. The plate surface fixing member 25 is arranged such that an outer edge thereof is on the same plane surface as an edge surface of each optical sheet 115.

As described before, according to the present embodiment, the optical sheets 115 are overlapped with each other and the plate surface fixing member 25 is provided between the plate surfaces of the optical sheets 115 at the edge sections 115c thereof. According to such a configuration, the edge sections 115c of the optical sheets 115 are fixed with the plate surface fixing member 25. The plate surface fixing member 25 is between the plate surfaces of the optical sheets 115 at the edge sections 115c thereof. Therefore, in producing the optical member 124, even if material of the frame 116 would enter a space between the edge sections 115c of the optical sheets 115 that are overlapped with each other, the plate surface fixing member 25 restricts the material from entering the space.

### Third Embodiment

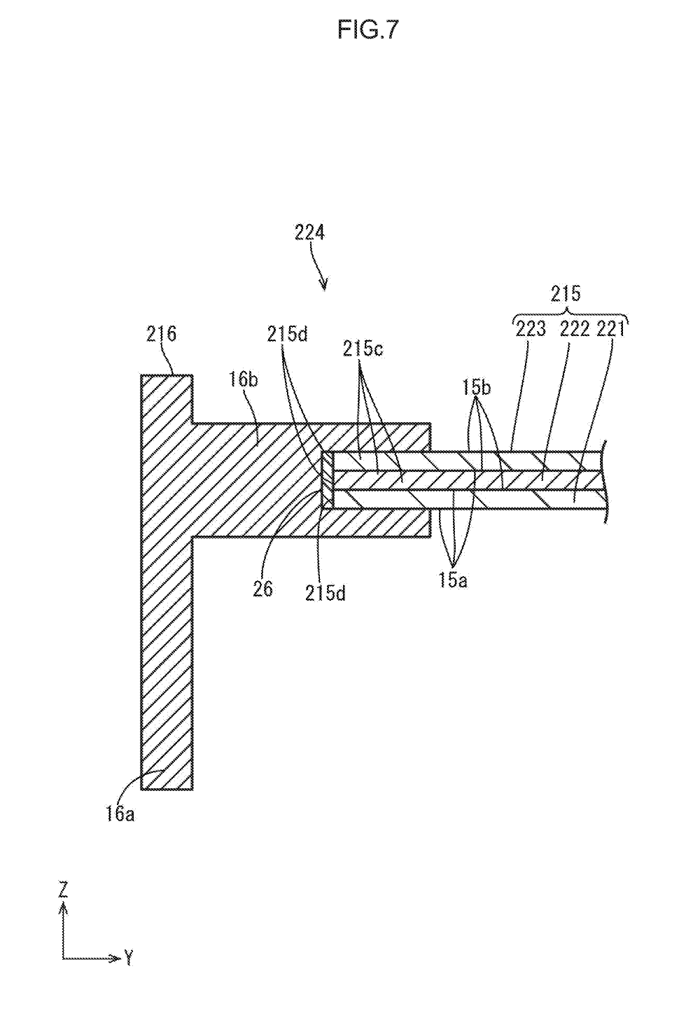

A third embodiment of the present technology will be described with reference to FIG. 7. In the third embodiment, the configuration of the first embodiment further includes an edge surface fixing member 26 for fixing edge surfaces 215d of optical sheets 215. Configurations, operations, and effects same as those of the first embodiment will not be described.

As illustrated in FIG. 7, an optical member 224 of this embodiment includes the edge surface fixing member 26 that is contacted with the edge surfaces 215d of the optical sheets 215 that are overlapped with each other and extends over the edge surfaces 215d. According to such a configuration, a space that may be between plate surfaces of the edge sections 215c of the overlapped optical sheets 215 is less likely to be open outwardly because of the edge surface fixing member 26. Therefore, in producing the optical member 224, even if material of the frame 216 would enter a space between the edge sections 215c of the optical sheets 215 that are overlapped with each other, the edge surface fixing member 26 restricts the material from entering the space. According to the present embodiment including the edge surface fixing member 26, a manufacturing cost may be increased compared to a configuration of the second embodiment. However, in the present embodiment, the resin material is further less likely to enter the space between the edge sections 215c of the optical sheets 215 in molding the frame 216 with resin.

As illustrated in FIG. 7, the edge surface fixing member 26 extends in the Z-axis direction (the thickness direction) to cross over the edge surfaces 215d of the micro lens sheet 221, the prism sheet 222, and the reflective-type polarizing sheet 223 that are overlapped with each other. The edge surface fixing member 26 extends over a substantially entire area of the thicknesses of the micro lens sheet 221, the prism sheet 222, and the reflective-type polarizing sheet 223. The edge surface fixing member 26 is made of resin such as epoxy resin. The edge surfaces 215d of the overlapped micro lens sheet 221, the prism sheet 222, and the reflective-type polarizing sheet 2234 are coated with the resin and the resin is cured to obtain the edge surface fixing member 26. The edge surface fixing member 26 is provided over an entire periphery of the edge sections 215c of the optical sheets 215.

As described before, according to the present embodiment, the optical sheets 215 are overlapped with each other and the edge surface fixing member 26 is provided to be contacted with the edge surfaces 215d of the optical sheets 215 and extends over the edge surfaces 215d. According to such a configuration, the edge sections 215c of the optical sheets 215 are fixed to each other with the edge surface fixing member 26. The edge surface fixing member 26 is contacted with the edge surfaces 215d of the optical sheets 215 and extends over the edge surfaces 215d. Therefore, in producing the optical member 224, even if material of the frame 216 would enter a space between the edge sections 215c of the optical sheets 215 that are overlapped with each other, the edge surface fixing member 26 restricts the material from entering the space.

### Fourth Embodiment

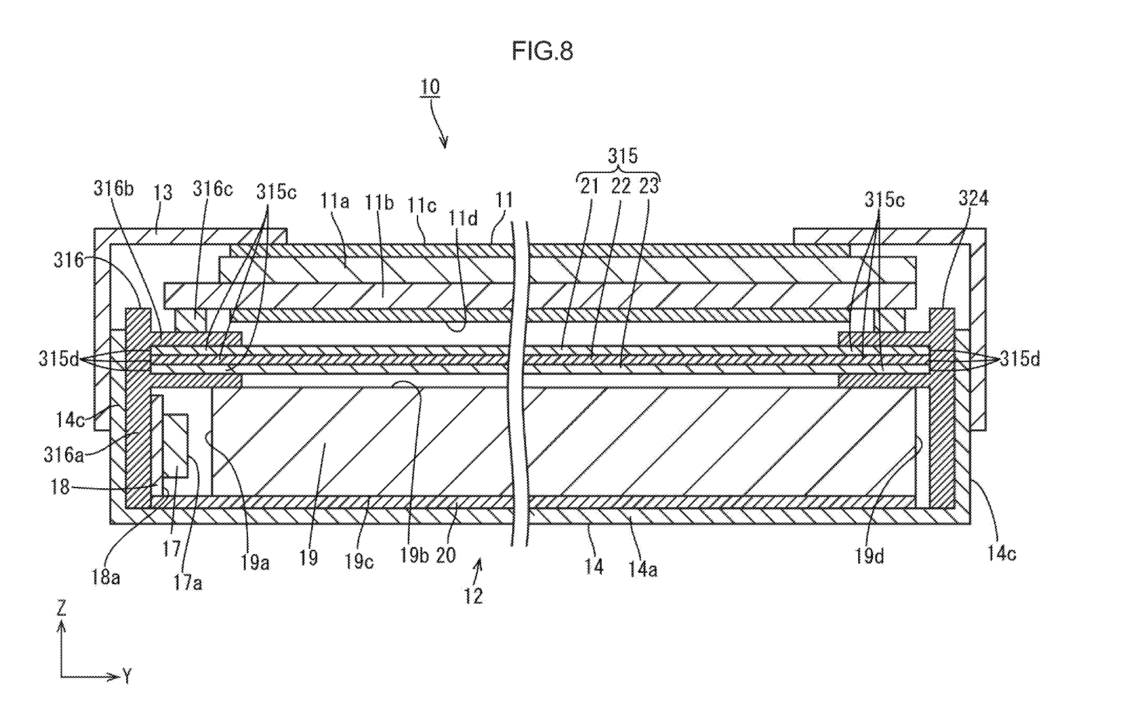

A fourth embodiment of the present technology will be described with reference to FIG. 8. In the fourth embodiment, arrangement of edge sections 315c of optical sheets 315 with respect to a frame 316 differs from that of the first embodiment. Configurations, operations, and effects same as those of the first embodiment will not be described.

As illustrated in FIG. 8, in an optical member 324 of this embodiment, the edge sections 315c of the optical sheets 315 are put within an inner frame section 316b of the frame 316 over an entire area of the inner frame section 316b. Specifically, the edge sections 315c of the optical sheets 315 extend from an inner peripheral section to an outer peripheral section of the inner frame section 316b of the frame 316. The edge sections 315c overlap a cushioning member 316c arranged on the outer peripheral section in a plan view. Therefore, the edge surfaces 315d of the optical sheets 315 are covered with the outer frame section 316a of the frame 316 from the outer side.

### Other Embodiments

The technology described herein is not limited to the embodiments described in the above sections and the drawings. For example, the following embodiments may be included in a technical scope.

(1) In each of the above embodiments, the tension is applied to the optical sheets by the frame. However, tension may not be applied to the optical sheets.

(2) In each of the above embodiments, the edge sections of the optical sheets are covered with the inner frame section of the frame from the front and back surfaces thereof. However, the inner frame section may not be on the front and back sides of the edge sections of the optical sheets but may be provided to cover the edge surfaces of the optical sheets.

(3) In each of the above embodiments, the frame has a frame shape that surrounds the optical sheets over the entire periphery thereof. However, the frame may not be necessarily formed continuously along the peripheral direction of the optical sheets. In such a configuration, the frame may be configured by several components.

(4) Other than the configuration of (3), only a specific part of the edge section of the optical sheet may be fit into the frame. In such a configuration, a frame width of a section corresponding to the specific part of the edge section of the optical sheet is selectively reduced.

(5) In each of the above embodiments, the optical sheets include a micro lens sheet, a prism sheet, and a reflective-type polarizing sheet. However, other types of optical sheets such as a diffuser sheet and a wavelength conversion sheet may be used. The diffuser sheet includes diffuser beads (diffusion particles) that apply diffusing effects to light as the optical components. The diffuser beads may be provided on at least one of a light entering plate surface and a light exit plate surface of a base member sheet. As another configuration of the diffuser sheet, the diffuser beads may be dispersed in the base member. The wavelength conversion sheet may include phosphors that convert wavelength of light as the optical component. The phosphors may be dispersed within the base member sheet.

(6) Other than each of the above embodiments, the stacking order of the optical sheets including the micro lens sheet, the prism sheet, and the reflective-type polarizing sheet may be altered as appropriate.

(7) In each of the above embodiments, the number of the optical sheets is three. However, the number of the optical sheets may be one, two, four or more.

(8) In each of the above embodiments, the frame has a white surface. However, the surface of the frame may be other colors than white such as black that is good in a light absorbing property.

(9) In the second embodiment, a specific forming area of the plate surface fixing member in the edge sections of the optical sheets may be altered as appropriate. For example, the plate surface fixing member may be provided on an entire area of parts of the edge sections of the optical sheets that are fit within the frame. Further, the plate surface fixing member may be partially provided in a peripheral direction of the optical sheets.

(10) In the third embodiment, a specific forming area of the edge surface fixing member in the edge sections of the optical sheets may be altered as appropriate. For example, the edge surface fixing member may be partially provided in a thickness direction of the three optical sheets. The edge surface fixing member may be partially provided in the peripheral direction of the optical sheets.

(11) Other than the first and fourth embodiments, the specific arrangement of the edge sections of the optical sheets with respect to the frame may be altered as appropriate.

(12) In each of the above embodiments, the outline of the optical sheet is rectangular but may be square, circular, or oval. In changing the outline of the optical sheet, the planar shape of the frame may be also altered according to the change of the outline of the optical sheet.

(13) In each of the above embodiments, the LED board (LEDs) is arranged such that the light guide plate has the light entering edge surface on one long-side edge surface thereof. However, the LED board (LEDs) may be arranged such that the light guide plate has the light entering edge surface on one short-side edge surface thereof.

(14) In each of the above embodiments, the backlight unit is a backlight unit of one-edge light entering type in which the LED board (LEDs) is arranged such that one of the four edge surfaces of the light guide plate is the light entering edge surface. However, the backlight unit may be a double-edge light entering type in which a pair of LED boards (LEDs) are arranged to sandwich the light guide plate with respect to the short-side direction such that a pair of long-side edge surfaces of the four edge surfaces of the light guide plate are light entering edge surfaces. Furthermore, the backlight unit may be a double-edge light entering type in which a pair of LED boards (LEDs) are arranged to sandwich the light guide plate with respect to the long-side direction such that a pair of short-side edge surfaces of the four edge surfaces of the light guide plate are light entering edge surfaces.

(15) Other than (14), the LED boards (LEDs) may be arranged such that three of the edge surfaces of the light guide plate are the light entering edge surfaces or the LED boards (LEDs) may be arranged such that four (all) of the edge surface of the light guide plate are the light entering edge surfaces.

(16) In each of the above embodiments, one LED board is arranged for one side of the light guide plate. However, LED boards may be arranged for one side of the light guide plate.

(17) In each of above embodiments, the top-surface-emitting type LEDs are used. However, side-surface-emitting type LEDs may be used as the light source. The number of LEDs mounted on the LED board may be altered as appropriate. A light source other than the LEDs (such as organic ELs) may be used.

(18) In each of the above embodiments, the edge-light type backlight unit is used. However, a direct-type backlight unit is also included in a scope of the present invention. In such a configuration, the direct-type backlight unit may not include a light guide plate that is included in the edge-light type backlight unit. The LED board may be arranged such that the LED mounting surface thereof is parallel to a plate surface of a bottom of a chassis and is opposite a plate surface of an optical sheet that is arranged in a light exit section of the chassis. The LED board is opposite the optical sheet with a clearance therebetween. The LED board may be preferably arranged such that the LEDs are arranged in a matrix within a plane surface of the bottom of the chassis. It may be further preferable to provide a reflection sheet to cover the mounting surface of the LED board and provide LED insertion holes in the reflection sheet for putting the LEDs therethrough. Furthermore, a diffuser lens for diffusing light may be arranged to cover the light emitting surface of the LED.

(19) In each of the above embodiments, the TFTs are used as the switching components of the liquid crystal display device. However, the technology described herein can be applied to liquid crystal display devices using switching components other than TFTs (e.g., thin film diodes (TFDs)). Furthermore, it can be applied to black-and-white liquid crystal display devices other than the color liquid crystal display device.

(20) In each of the above embodiments, the liquid crystal display device of a transmission type is used. However, a liquid crystal display device of a semi-transmission type may be included in the scope of the invention.

(21) In each of the above embodiments, the liquid crystal display device includes the liquid crystal panel as the display panel. However, display devices including other types of display panels (such as a micro elector mechanical systems (MEMS) display panel) may be included in the scope of the invention.

(22) Each of the above embodiments includes the liquid crystal panels that are classified as small sized or small to middle sized panels. However, liquid crystal panels that are classified as middle sized or large sized (or supersized) panels having screen sizes from 20 inches to 100 inches are also included in the scope of the present invention. Such display panels may be used in electronic devices including television devices, digital signage, and electronic blackboard.

### EXPLANATION OF SYMBOLS

10: liquid crystal display device (display device), 11: liquid crystal panel (display panel), 12: backlight unit (lighting device), 14: casing, 14c: side section, 15, 115, 215, 315: optical sheet, 15a, 115a: light entering plate surface, 15b, 115b: light exit plate surface, 15c, 115c, 215c, 315c: edge section, 15d, 115d, 215d, 315d: edge surface, 16, 116, 216, 316: frame (light blocking member), 16b, 316b: inner frame section (light guide plate pressing member, panel receiving section), 17: LED (light source), 19: light guide plate, 19a: light entering edge surface, 19b: light guide plate light exit plate surface, 21, 121, 221: micro lens sheet (optical sheet), 21b: micro lens portion (optical component), 22, 122, 222: prism sheet (optical sheet), 22b: prism portion (optical component), 23, 123, 223: reflective-type polarizing sheet (optical sheet), 23a1: recess section (optical component), 24, 124, 224, 324: optical member, 25: plate surface fixing member, 26: edge surface fixing member

1. An optical member comprising:
an optical sheet including a pair of plate surfaces, one of the plate surfaces being a light entering plate surface through which light enters and another one of the plate surfaces being a light exit plate surface through which the light exits, and the optical sheet including an optical component that provides an optical effect on transmission light; and
a light blocking member having a light blocking property and extending along an edge section of the optical sheet and the edge section being put within the light blocking member.

2. The optical member according to claim 1, wherein
the optical sheet is made of material having linear expansion coefficient greater than that of the light blocking member, and
the edge section is put within the light blocking member such that the optical sheet is applied with tension to be pulled outwardly along the plate surfaces.

3. The optical member according to claim 1, wherein the optical sheet includes the optical component that forms an uneven structure on one of the light entering plate surface and the light exit plate surface.

4. The optical member according to claim 1, wherein the light blocking member is arranged to cover the light entering plate surface and the light exit plate surface of the edge section of the optical sheet.

5. The optical member according to claim 1, wherein the optical sheet includes optical sheets that are stacked on each other, and the optical member further comprising a plate surface fixing member that is between the plate surfaces of the optical sheets at the edge sections.

6. The optical member according to claim 1, wherein the optical sheet includes optical sheets that are stacked on each other, and the optical member further comprising an edge surface fixing member that is in contact with edge surfaces of the optical sheets and extends over the edge surfaces.

7. A lighting device comprising:
the optical member according to claim 1;
a light source that supplies light to the optical sheet; and
a light guide plate having outer peripheral edge surface and a pair of plate surfaces, a part of the outer peripheral edge surface being a light entering edge surface through Which light from the light source enters and one of the plate surfaces being a light guide plate light exit plate surface that is opposite the light entering plate surface of the optical sheet and through which the light exits, wherein
the light blocking member includes a light guide plate pressing section that presses edge section of the light guide plate from a light guide plate light exit plate surface side.

8. The lighting device according to claim 7, further comprising a casing in which the optical sheet, the light blocking member, and the light source are arranged, wherein the casing includes a side section that is in contact with an outer surface of the light blocking member.

9. A display device comprising:
the lighting device according to claim 7; and
a display panel displaying an image with using light supplied by the lighting device, wherein the light blocking member includes a panel receiving section that receives an edge section of the display panel.
